(19) United States
(12) Patent Application Publication
(10) Pub. No.: US 2006/0017656 A1
(43) Pub. Date: Jan. 26, 2006

(54) Image intensity control in overland night vision systems

(75) Inventor: Shunji Miyahara, Yokohama-shi (JP)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/899,287

(22) Filed: Jul. 26, 2004

(51) Int. Cl. G09G 5/00

(52) U.S. Cl. 345/8

(57) ABSTRACT

A near-infrared night vision system includes an infrared source that emits a near-infrared beam toward an object. The infrared beam is reflected from the object as a reflected beam. A camera receives the reflected beam and generates an image signal in response to the reflected beam. An image processor receives the image signal, generates a distribution of the intensities, compares the distribution to a threshold, and generates a display signal based on the comparison. A over-laid heads up display receives the display signal, generates a reflected image in response to the display signal, and overlays the reflected image over the actual image of the object.

### BACKGROUND

The present invention generally relates to an infrared night vision system. Specifically, the present invention relates to a near-infrared night vision system.

Despite technological developments in automotive safety during the past few decades, a driver still faces the danger of not seeing many hazards, such as pedestrians, animals, or other cars, after sunset that are easily avoided during the daytime. Recently, night vision monitoring systems have appeared in certain vehicles. These systems are based on a camera that detects far-infrared radiation with a wavelength of, for example, between of about 8 μm to 14 μm and displays the detected image at the lower part of the windshield. Such radiation provides useful thermal information of objects, which the human eye cannot detect. Far-infrared night vision system are passive systems since the illumination source is not necessary. These systems are capable of monitoring objects that are as far away as 400 m from the vehicle because the propagation path is a single trip. However, the cameras for these systems are quite costly.

More recently, near-infrared night vision systems have appeared in the automotive market. These systems are active systems in which a near-infrared source emits radiation with a wavelength, for example, between about 0.8 μm to 0.9 μm to illuminate objects in the road. Since this wavelength is invisible, the system can keep the illumination source in a high position even though there are on-coming vehicles. Thus, long range traffic conditions are visible to the driver as if the headlight is in high beam condition even though the actual leadlight is in low beam condition. A camera detects the reflection from the object, and the reflected image is displayed at the lower part of the windshield. The near-infrared night vision has a limited range of about, for example, 150 m, but the image is similar to that visualized by human eye, and the camera cost is much lower than that of the far-infrared night vision system. Similar to the aforementioned far-infrared system, the image is projected in a non-overlaid heads-up display, in which the driver has to compare the image in the lower part of the windshield with the actual image of the object.

To avoid the process of comparing the camera image with the actual image, which can reduce driver fatigue, an over-laid heads-up display is desirable, in which the camera image is overlaid on the actual image. However, there are several problems associated with over-laid heads-up displays. For instance, the positions of the images have to coincide with each other precisely, the images have to be similar to each other, and the camera image intensity has to be adequate. Although the positions of the images can be managed by the geometrical transformation of the camera, and the image similarities can be obtained in the near-infrared system since the wavelength between near-infrared radiation and visible light are similar, unfortunately, heretofore, there has been no effective method proposed to control the image intensity of the camera image, even though this control is critical for over-laid heads-up displays, since too strong or saturated image disturbs the actual image and too weak of an image is not effective.

In view of the above, it is apparent that there exists a need for a near-infrared night vision system that is able to suppress the saturation of the camera image in the over-laid heads-up display and keep the balance of the intensity between the camera and the actual images, since the saturation disturbs the actual image and may result in an accident.

### SUMMARY

In satisfying the above need, as well as overcoming the enumerated drawbacks and other limitations of the related art, the present invention provides a near-infrared night vision system and method that controls the intensity of a reflected beam received by a camera in an over-laid heads-up display.

In a general aspect, an infrared source emits a near-infrared beam toward an object, and the infrared beam is reflected from the object as a reflected beam. The camera receives the reflected beam and generates an image signal in response to the reflected beam. An image processor receives the image signal, generates a distribution of intensities, compares the distribution to a threshold, and generates a display signal based on the comparison. A heads up display receives the display signal, generates a reflected image in response to the display signal, and overlays the reflected image over the actual image of the object.

In various embodiments, the image processor reduces the intensities received by the camera when the number of the cells having intensities exceeding the threshold is higher than a pre-determined value and increases the intensities received by the camera when the number is lower than the value. An attenuator may be employed to control the intensities received by the camera in response to the comparison between the distribution and the threshold. Alternatively, a power supply coupled to the infrared source may be employed. The power source modifies the power to the infrared source in response to the comparison between the distribution and the threshold.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1A is a schematic view of a near-infrared night vision system in accordance with an embodiment of the present invention;

FIG. 1B is a schematic view of the system of FIG. 1A implemented in a vehicle;

FIG. 2A is schematic of an image at night without the use of a night vision system;

FIG. 2B is a schematic of the image of FIG. 2A with the use of a near-infrared night vision system;

FIG. 3 is a schematic view of a far-infrared night vision system; and

FIG. 4 is a schematic of a near-infrared night vision system in accordance with another embodiment of the present invention.

### DETAILED DESCRIPTION

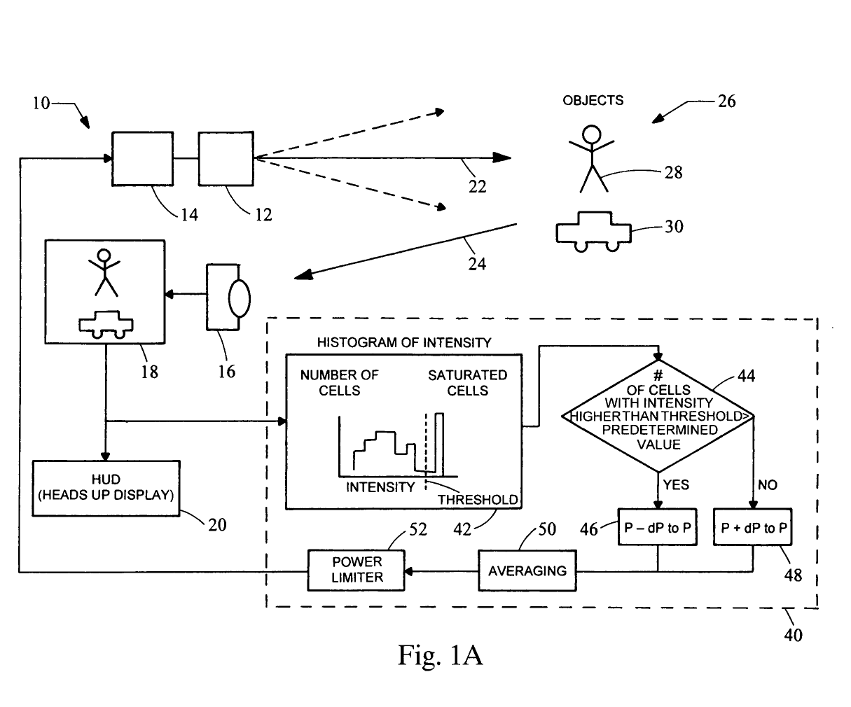

Referring now to FIGS. 1A and 1B, a near-infrared night vision system embodying the principles of the present invention is illustrated therein and designated at 10. As its primary components, the system 10 includes an illuminating source 12 with a power supply 14, a camera 16, an image processor 18, and a heads up display 20.

The system 10 resides in a vehicle 21, and when in use, the source 12, such as a halogen, laser diode or light-emitting diode, projects a near-infrared radiation beam 22 at one or more objects 26, for example, a pedestrian 28 or a car 30, or both. The radiation beam 22 has a power that is sufficient to illuminate the objects 26. In certain embodiments, the beam has a wavelength between about 0.8 μm to 0.9 μm for a halogen source or has a bandwidth of about 3 nm for a laser diode.

The camera 16 detects a reflected beam 24 from the objects 26 and generates an image signal in response to the reflected beam. The image processor 18 processes the image signal (IS) from the camera 16 and provides a display signal (DS) to the heads up display 20. The heads up display 20 generates a reflected image in response to the display signal and-overlays the reflected image over the actual image of the objects 26 as seen through the windshield of the vehicle 30. The heads up display can be of common construction. In some configurations, the reflected image is displayed directly on the windshield. Alternatively, the heads up display 20 includes a semi-transparent glass on which the reflected image is displayed and through which the actual image can be seen.

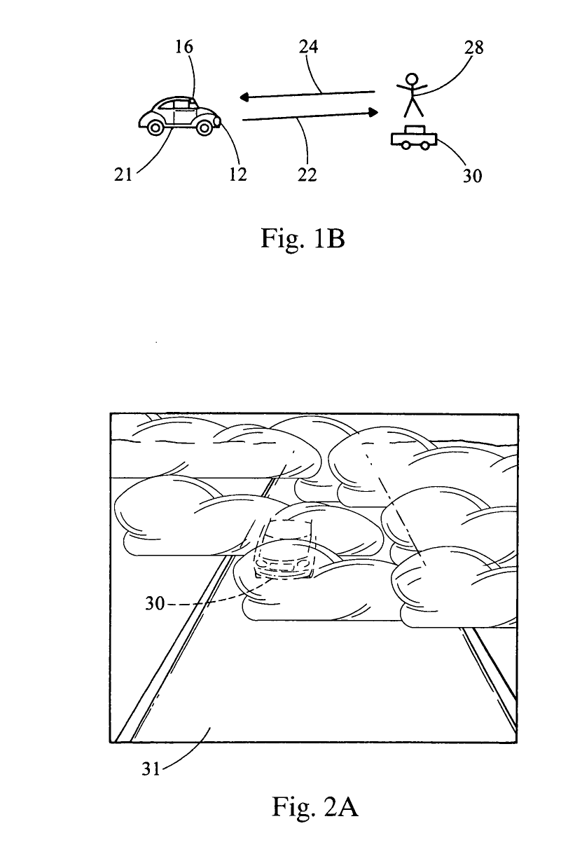

For purposes of illustration, FIG. 2A illustrates the oncoming vehicle 30 on a road 31 as might be seen at night by the driver of the vehicle 21, and FIG. 2B illustrates a view of the vehicle 30 and a set of poles 32 with the use of near-infrared illumination. FIG. 2B also illustrates the pedestrian 28 at a distance associated with the high-beam range (that is, beyond the low-beam range) that may not be seen without the use of the illumination system. The saturation of the camera image in the over-laid near-infrared night vision system caused by the headlamps of the vehicle 30 might disturb the view of the pedestrian 28.

The camera 16 can be, for example, a CCD camera or a CMOS camera with a plurality of cells that captures the reflection from the objects 26. Since the reflected beam 24 to the camera 16 has a distribution of intensities that may change significantly during the operation of the system 10, certain cells may become saturated if the camera does not have a sufficient dynamic range. If saturation occurs, the reflected image in the heads up display will disturb the view of the actual image. For example, the reflected image of the poles 32 or the front of the car 30 in FIG. 2B may interfere with the actual image of the objects since this is an over-laid system.

The dynamic range of a reflected beam can be determined from the reflection coefficients of typical objects in front of the camera, output-power of the illuminating source, and the range between the objects and the camera. In particular, the intensity of the power received by the camera is inversely proportional to the 4^{th} power of the distance between the object and the camera. For example, the reflection coefficient is usually in the range between about 0.1 to 1.0, and the effective operating distance of a near-infrared night vision system is between the camera and the object is usually in the range between about 5 m to 150 m. Thus, a camera needs a dynamic range of about 70 dB to view the object without saturation, as determined by adding the following two expressions
10 dB=10 log (1.0/0.1)
60 dB=10 log (150/5)⁴

Thus, if the dynamic range of the camera is not sufficient, the saturation of the camera cells may occur, for example, as the object moves closer to the camera and the intensity of the source is high. However, the system 10 controls the intensity received by the camera 16 so that the reflected image is not saturated in a way that disturbs the view of the actual image when the reflected image is displayed in the over-laid heads up display 20, and, therefore, the dynamic range of the camera can be used effectively. Hence, potentially fatal accidents associated with the disturbance of the actual image may be eliminated.

The system 10 controls saturation of the cells in the camera 16 by varying the power from the power supply 14 to the source 12 with a process 40 implemented as an algorithm, for example, in the image processor 18. In essence, the system 10 controls the saturation by controlling the illumination power on the basis of an intensity histogram 42, which represents a distribution of the number of camera cells exposed to a particular intensity.

Specifically, after the camera 16 captures an image, process 40 generates the histogram 42. In some circumstances, the camera cells having the intensity larger than the threshold may be considered saturated cells. A decision step 44 determines if the number of the cells with intensities exceeding the threshold is larger than a pre-determined number. If so, then step 46 calculates a reduced power, and step 50 averages the value of the reduced power, for example, by integration to provide a smooth transition and an appropriate time delay that is compatible with human eyes. The averaged power value is sent to a power limiter 52, which, in turn, reduces the power (P) from the power supply 14 to the source 12.

Hence, step 44 determines whether the number of the cells with the high intensity exceeding the threshold is larger or smaller than the pre-determined value, and step 48 calculates an increased or decreased power and provides this value to the averaging step 50, where a time delay is produced, before the power limiter 52 increases or decreases the power (P) from the power supply 14 to the source 12.

Accordingly, the system 10 generates a reflected image overlaid with the actual image in a manner that does not disturb the view of the actual image by reducing the saturation of the camera cells. In this way, the dynamic range of the camera is fully utilized, and the requirement for the large dynamic range is reduced considerably, which reduces cost requirements, since cameras with large dynamic ranges are typically quite costly.

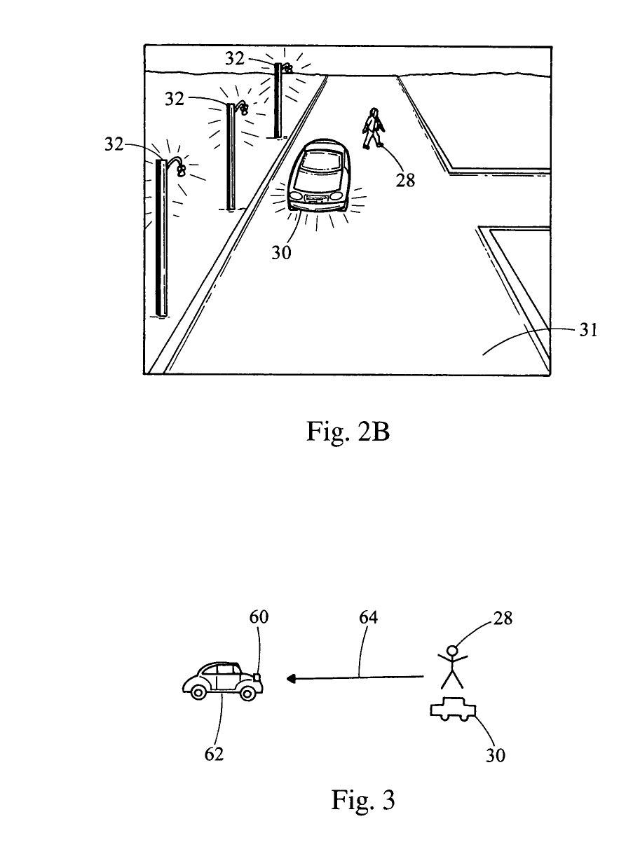

For the sake of comparison, FIG. 3 illustrates a typical configuration of a far-infrared night vision system in which a far-infrared camera 60 is mounted on a vehicle 62. The camera 30 detects a radiation beam 64 corresponding to thermal emissions of the person 24 or vehicle 26. Referring to Table 1 below, near-infrared imaging systems, such as the system 10, provides certain benefits over far-infrared systems. A particular drawback of far-infrared systems is their costs. With near-infrared systems, conventional devices such as halogen or laser diode sources and CCD or CMOS cameras can be used for the source 12 and camera 16, respectively. Therefore, the cost of near-infrared systems are lower than that of far-infrared systems. Moreover, the image of the object appears more natural in near-infrared systems than in far-infrared systems.

TABLE 1
Comparison between Far-infrared and Near-infrared systems

| Item | Far infrared (FIR) | Near infrared (NIR) |
|---|---|---|
| Basic: | | |
| Wavelength | 8 to 17 μm | 0.9 μm |
| Band | 6 μm | 2-3 nm |
| Active/passive | passive | active |
| Image resolution | low | high |
| | | (large number of cells) |
| System: | | |
| Azimuth angles | >11 degrees | >14 degrees |
| | (limited by number | (with large cell number) |
| | of cells) | |
| Performance: | | |
| Range | >400 m | 150-200 m |
| Human detection | good | depends on clothes |
| Lane detection | difficult but possible | possible |
| Road side object | fair, | good |
| detection | necessary to process | |
| Quality of image | not good, | good |
| | necessary to process | |
| Transmission | | |
| at 300 m: | | |
| Rain | good | fair |
| (medium 12.5 mm/h) | | |
| Fog (light) | fair | poor |

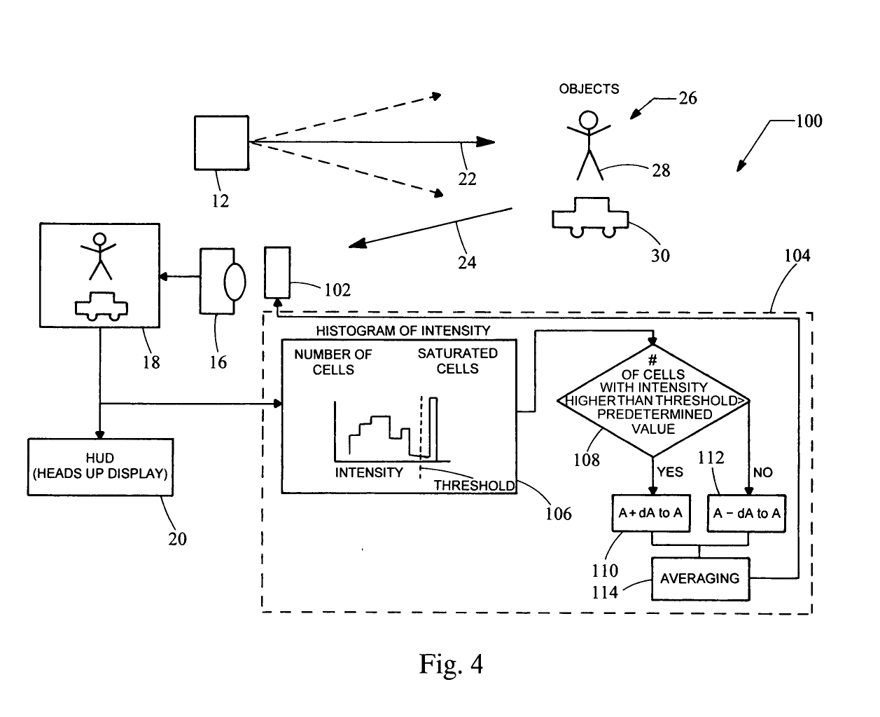

Referring now to FIG. 4, there is shown a system 100 in accordance with an alternative embodiment of the present invention. The system 100 eliminates the power limiter 52 for the power supply 14 of the aforementioned system 10 but incorporates an attenuator 102 positioned between the camera 16 and the objects 26.

The system 100 controls the saturation of the camera cells by varying the attenuation of the reflected image 24 with an attenuator 102 with a process 104 implemented, for example, as an algorithm in the image processor 18 based on an intensity histogram 106 of the intensity received by the individual cells of the camera 16.

Specifically, as the camera 16 receives the reflected beam 24 of the objects 26 through the attenuator 102, the process 104 generates the histogram 106, which indicates the number of cells at each intensity. The cells having an intensity larger than the threshold may be considered saturated cells. A decision step 108 determines if the number of the cells with an intensity exceeding the threshold is larger than a pre-determined value, and, if so, step 110 calculates an increased attenuation. The value of the increased attenuation is then averaged in step 114, for example, by integration to provide an appropriate time delay that is compatible with human eyes. The averaged attenuation value is then provided to the attenuator 102 to further attenuate the intensity of the reflected image received by the camera 16.

If step 108 determines that the cells at the highest intensity do not exceed the threshold value, then step 112 calculates a decreased attenuation value and provides this value to the averaging step 114, where again a time delay is produced before the averaged attenuation value is provided to the attenuator 102 to decrease the attenuation of the reflected beam 24 received by the camera 16.

In sum, the system 100 generates a reflected image of an object which is overlaid on the actual image in the heads up display 20. The reflected image does not disturb the view of the actual image since the system 100 attenuates the intensity of the reflected beam received by the camera 16. Again, the dynamic range of the camera is used effectively and the requirement for the large dynamic range is reduced remarkably, which reduces cost requirements. Moreover, the attenuation control operates independently from the power supplied to the source 12, and the attenuator 102 itself may be a simple mechanism that is commercially available. This enables easy installation of the system 100 in a vehicle. Moreover, similar to the system 10, the system 100 uses low cost hardware to minimize costs.

As a person skilled in the art will readily appreciate, the above description is meant as an illustration of various implementations of the principles this invention. This description is not intended to limit the scope or application of this invention in that the invention is susceptible to modification, variation and change, without departing from spirit of this invention, as defined in the following claims.

What is claimed is:

1. A night vision system for a vehicle comprising:
an infrared source that emits an near-infrared beam toward an object, the infrared beam being reflected from the object as a reflected;
a camera that receives the reflected beam and generates an image signal in response to the reflected beam;
an image processor that receives the image signal, generates a distribution of the intensities, compares the distribution to a threshold, and generates a display signal based on the comparison; and
an over-laid heads up display that receives the display signal, generates a reflected image in response to the display signal, and overlays the reflected image over the actual image of the object.

2. The system of claim 1 wherein the image processor reduces the intensities received by the camera when the number of cells of the camera having an intensity exceeding the threshold is larger than a pre-determined value.

3. The system of claim 1 wherein the image processor increases the intensities received by the camera when the number of cells of the camera having an intensity exceeding the threshold is smaller than a pre-determined value.

4. The system of claim 1 further comprising an aftenuator that modifies the intensities received by the camera in response to the comparison between the distribution and the threshold.

5. The system of claim 1 further comprising a power supply coupled to the infrared source, the power source modifying the power supplied to the infrared source in response to the comparison between the distribution and the threshold.

6. The system of claim 1 wherein the near-infrared beam from the source has a wavelength of between about 0.8 μm to 0.9 μm or has a bandwidth of about 3 nm at the wavelength in the near infrared.

7. The system of claim 1 wherein the system is capable of viewing objects at a distance from the camera between about 5 m and 150m.

8. The system of claim 1 wherein the distribution of the intensities is a histogram of the number of camera cells at particular intensities.

9. A method of viewing objects at night comprising:
emitting a near-infrared beam from an infrared source toward an object, the infrared beam being reflected from the object as a reflected beam with a intensities;
receiving the reflected beam with a camera and generating an image signal in response to the reflected beam;
receiving the image signal with an image processor, processing the image signal to generate a distribution of the intensities, comparing the distribution to a threshold, and generating a display signal based on the comparison; and
receiving the display signal with a over-laid heads up display, generating a reflected image in response to the display signal, and overlaying the reflected image over the actual image of the object in the heads up display.

10. The method of claim 9 further comprising reducing the intensities received by the camera when the number of cells of the camera having an intensity exceeding the threshold is larger than a pre-determined value.

11. The method of claim 9 further comprising increasing the intensities received by the camera when the number of cells of the camera having an intensity exceeding the threshold is smaller than a pre-determined value.

12. The method of claim 9 further comprising modifying the intensities with an attenuator in response to the comparison between the distribution and the threshold.

13. The method of claim 9 further comprising modifying the power supplied to the infrared source in response to the comparison between the distribution and the threshold.

14. The method of claim 9 wherein the near-infrared beam from the source has a wavelength of between about 0.8 μm to 0.9 μm or has a bandwidth of about 3 nm in the near infrared.

15. The method of claim 9 wherein the distribution of the intensities is a histogram of the number of camera cells at particular intensities.
